(19) United States
(12) Patent Application Publication
(10) Pub. No.: US 2004/0179790 A1
(43) Pub. Date: Sep. 16, 2004

(54) Disposable package lens welding kit

(76) Inventors: Victor J. Kardos, Tustin, CA (US); Kirk Matthes, Fountain Valley, CA (US)

Correspondence Address: IRELL & MANELLA LLP, 840 NEWPORT CENTER DRIVE, SUITE 400, NEWPORT BEACH, CA, 92660, US

(21) Appl. No.: 10/389,357

(22) Filed: Mar. 13, 2003

(51) Int. Cl. G02B 6/36

(52) U.S. Cl. 385/88

(57) ABSTRACT

A photonic test package that includes one or more detachable weld plates that allow components to be removed from the package. The weld plates may support relatively inexpensive optical components such as lenses, collimators and optical isolators. A photonic device such as a laser diode or photodetector is permanently attached to the package base plate. The weld plates are attached to the package base plate by fasteners that allow the plates to be removed from the package. The optical components are aligned with the photonic device welded/soldered to the weld plates. Test data may be taken regarding any weld/solder component shift. The weld plates and accompanying optical components can be removed and replace with a new set of plates/components so that the weld/solder process can be repeated with the same package without discarding the relatively expensive photonic device.

### BACKGROUND OF THE INVENTION

1. Field of the Invention

The subject matter disclosed generally relates to photonic packages.

2. Background Information

Laser diodes and photodetectors are typically assembled into a “package” that is mounted to a printed circuit board. A fiber optic cable is attached to the end of the package with a weld or solder process. The package may also contain lenses to focus the light from a laser diode into the fiber optic cable.

The laser diode, lenses and fiber optic cable are welded or soldered to a base plate of the package. The weld/solder process causes the components to shift within the package. The component shift may result in a misalignment between the laser diode and the fiber optic cable. An extensive amount of testing and data collection is typically required to predict and compensate for the weld/solder shift. Testing requires welding/soldering components to a package. After data is collected the package and attached components are discarded. A number of packages are typically welded/soldered before the developer has enough data to predict weld/solder component shift. The laser diode may be a relatively expensive component. Discarding the packages and attached laser diodes after each assembly increases the cost of developing the weld/solder process.

### BRIEF SUMMARY OF THE INVENTION

A photonic test package that includes a weld plate coupled to a package base plate. The weld plate supports an optical element that is aligned with a photonic device mounted to the base plate. The weld plate is attached to the base plate by a fastener.

### BRIEF DESCRIPTION OF THE DRAWINGS

FIG. 1 is a perspective view of a photonic test package;

FIG. 2 is a perspective view of a test package that includes a first weld plate and a second weld plate;

FIG. 3 is a perspective view of a test package that includes the second weld plate and a detachable snout plate;

FIG. 4 is a perspective view of a test package that includes the second weld plate;

FIG. 5 is a perspective view of a test package with the first weld plate, the second weld plate and the snout plate, wherein a fiber optic cable is attached to a snout of the snout plate.

### DETAILED DESCRIPTION

Disclosed is a photonic test package that includes one or more detachable weld plates that allow components to be removed from the package. The weld plates may support relatively inexpensive optical components such as lenses, collimators and optical isolators. A photonic device such as a laser diode or photodetector is permanently attached to the package base plate. The weld plates are attached to the package base plate by fasteners that allow the plates to be removed from the package. The optical components are aligned with the photonic device and welded/soldered to the weld plates. Test data may be taken regarding any weld/solder component shift. The weld plates and accompanying optical components can be removed and replace with a new set of plates/components so that the weld/solder process can be repeated with the same package without discarding the relatively expensive photonic device.

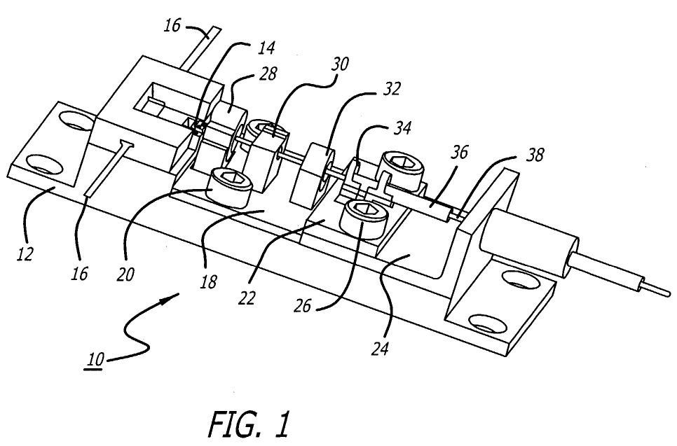

Referring to the drawings more particularly by reference numbers, FIG. 1 shows a photonic test package 10. The package 10 includes a package base plate 12. A photonic device 14 is mounted to the base plate 12. The photonic device 14 may be a laser diode or a photodetector. Although a laser diode and photodetector are described, it is to be understood that the photonic device 14 may be a different type of device.

The photonic device 14 is electrically connected to a pair of leads 16. Current can be provided to the leads 16 to power the device 14. By way of example, current can be provided to a laser diode device to cause emission of a laser beam. Alternatively, a voltage may be applied to a photodetector to detect light directed onto the detector.

The test package 10 may include a first weld plate 18 that is attached to the base plate 12 by a pair of fasteners 20. The package 10 may further-have a second weld plate 22 and a snout plate 24 that are attached to the base plate 12 by another set of fasteners 26. The base plate 12, weld plates 18 and 22, and snout plate 24 are all typically constructed from a metal material, although it is to be understood that a non-metallic material may be employed.

The first weld plate 18 may support one or more optical elements 28, 30 or 32. By way of example the optical elements 28, 30 and 32 may be a collimator, optical isolator and lens, respectively. The second weld plate 22 may support a weld clip 34 that is attached to a ferrule 36 of a fiber optic cable 38. The fasteners 20 and 26 allow the snout plate 24 and weld plates 18 and 22 to be removed and replaced with another set of plates 18, 22 and 24, and components 28, 30, 32, 34, 36 and 38.

In operation, the weld plates 18 and 22, and snout plate 24 are attached to the base plate by fasteners 20 and 26. The optical elements 28, 30 and 32 are then aligned with the photonic device 14 and welded/soldered to the first weld plate 18. By way of example, the collimator 38 may be attached the weld plate 18 first, followed by attachment of the isolator 30 and then the lens 32. The optical elements 28, 30 and 32 maybe initially offset so that the elements 28, 30 and 32 are properly aligned with the photonic device 14 after a weld/solder induced shift of position.

The weld clip 34 is attached to the second weld plate 22 and the fiber ferrule 36 is then attached to the clip 34. Data is taken regarding the post weld/solder shift of the components 28, 30, 32, 34 and 38. After the data is taken, the fasteners 20 and 26 are detached from the base plate 12, and the weld plates 18 and 22, and snout plate 24 are removed from the package 10. New plates 18, 22 and 24 are attached to the base plate 12 and the process is repeated. The use of weld plates allows a package designer to conduct multiple weld/solder processes without having to discard the photonic device 14. The photonic device 14 is typically more expensive than the replaceable components 28, 30, 32, 34 and 38.

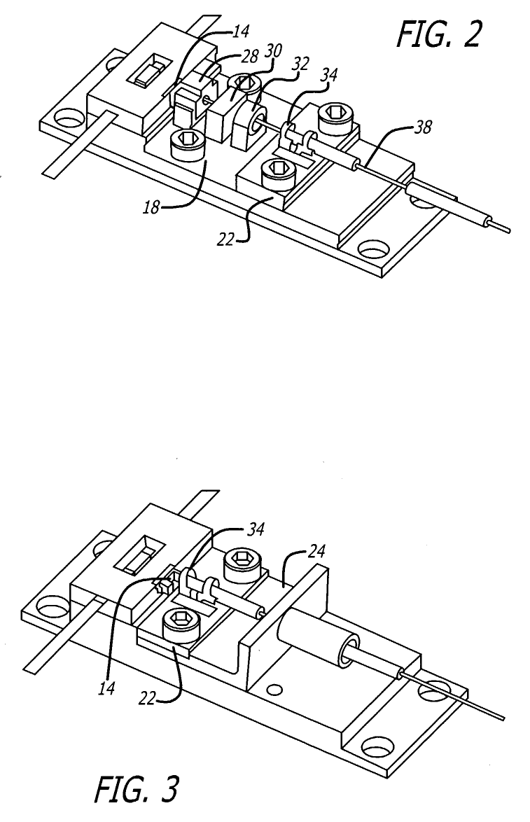

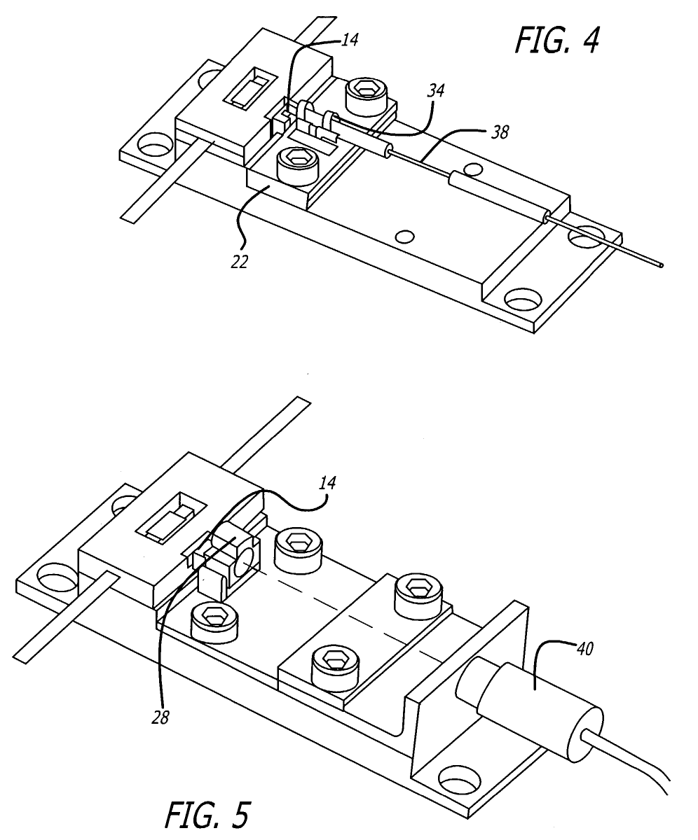

Although attachment of the weld plates 18 and 22, snout plate 24 and components 28, 30, 32, 34 and 38 are shown and described, it is to be understood that other package configurations may be tested and developed. FIGS. 2, 3, 4 and 5 show other exemplary configurations. The test package 10 may not include the snout plate 24 as shown in FIG. 2, or the first weld plate 18 and optical components 28, 30 and 32 as shown in FIG. 3. As shown in FIG. 4 the test package 10 may only include the second weld plate 22, weld clip 34 and a fiber optic cable 38 that is aligned with the photonic device 14.

FIG. 5 shows an embodiment wherein a detector 40 is used to align the collimator 28 with the photonic device 14. The detector 40 can also be used to align the other optical elements 30 and 32 to the photonic device 14 before attachment of the fiber optic cable 38 in the other embodiments shown in FIGS. 1 and 2.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A photonic test package, comprising:
a base plate;
a photonic device mounted to said base plate;
a first weld plate;
an optical element mounted to said first weld plate; and,
a fastener that couples said weld plate to said base plate.

2. The package of claim 1, further comprising a second weld plate that is coupled to said base plate by a fastener.

3. The package of claim 1, further comprising a detachable snout plate coupled said base plate.

4. The package of claim 1, wherein said optical element is welded to said first weld plate.

5. The assembly of claim 2, further comprising a weld clip welded to said second weld plate and a fiber optic cable attached to said weld clip.

6. The package of claim 1, wherein said optical element is a lens.

7. The package of claim 1, wherein said optical element is a fiber optic cable.

8. The package of claim 1, wherein said photonic device is a laser diode.

9. The package of claim 1, wherein said photonic device is an optical receiver.

10. A photonic test package, comprising:
a base plate;
a photonic device mounted to said base plate;
an optical element; and,
means for coupling said optical element to said base plate.

11. The package of claim 10, wherein said means includes a first weld plate that is coupled to said base plate by a fastener.

12. The package of claim 11, further comprising a second weld plate that is coupled to said base plate by a fastener.

13. The package of claim 11, further comprising a detachable snout plate coupled said base plate.

14. The package of claim 11, wherein said optical element is a lens.

15. The package of claim 11, wherein said optical element is a fiber optic cable.

16. The assembly of claim 12, further comprising a weld clip welded to said second weld plate and a fiber optic cable attached to said weld clip.

17. The package of claim 10, wherein said photonic device is a laser diode.

18. The package of claim 10, wherein said photonic device is an optical receiver.

19. A method for aligning an optical element with a photonic device, comprising:
attaching a first weld plate to a base plate that supports a photonic device;
welding an optical element to the first weld plate; and,
removing the first weld plate and optical element from the base plate.

20. The method of claim 19, further comprising attaching a second weld plate to the base plate, welding a weld clip and fiber optic cable to the second weld plate and removing the second weld plate, weld clip and fiber optic cable from the base plate.
